(19) United States
(12) Patent Application Publication
(10) Pub. No.: US 2021/0240185 A1
(43) Pub. Date: Aug. 5, 2021

(54) SHOOTING CONTROL METHOD AND UNMANNED AERIAL VEHICLE

(71) Applicant: SZ DJI TECHNOLOGY CO., LTD., Shenzhen (CN)

(72) Inventors: Chaofeng YANG, Shenzhen (CN); Gang HE, Shenzhen (CN); Chengqun ZHONG, Shenzhen (CN); Xianghua JIA, Shenzhen (CN)

(21) Appl. No.: 17/215,881

(22) Filed: Mar. 29, 2021

Related U.S. Application Data
(63) Continuation of application No. PCT/CN2018/109124, filed on Sep. 30, 2018.

(51) Int. Cl. G05D 1/00; G05D 1/08; H04N 7/18; B64C 39/02

(52) U.S. Cl. CPC G05D 1/0094; G05D 1/0808; B64C 2201/123; B64C 39/024; B64C 2201/027; H04N 7/188

(57) ABSTRACT

A shooting control method includes obtaining a distance between an unmanned aerial vehicle and a target point of a current shooting interval, determining whether the unmanned aerial vehicle satisfies a shooting time prediction condition according to the distance, predicting a time point at which the unmanned aerial vehicle arrives at the target point according to the distance if the unmanned aerial vehicle satisfies the shooting time prediction condition, and controlling an image device carried by the unmanned aerial vehicle to shoot at the time point.

### CROSS-REFERENCE TO RELATED APPLICATION

This application is a continuation of International Application No. PCT/CN2018/109124, filed Sep. 30, 2018, the entire content of which is incorporated herein by reference.

### TECHNICAL FIELD

The present disclosure relates to the field of unmanned aerial vehicle and, in particular, to a shooting control method and an unmanned aerial vehicle.

### BACKGROUND

To meet needs, such as digital city construction, security, and forest fire prevention, map information is built via a manner of aerial photography. In recent years, with the development of unmanned aerial vehicle technology, unmanned aerial vehicles are more and more applied to the field of aerial mapping because of advantages of the unmanned aerial vehicle, such as lightweight, flexibility, strong programming ability, and low environmental requirements. The mapping efficiency is greatly improved with the mobility and intelligence of the unmanned aerial vehicle.

During the aerial mapping, the unmanned aerial vehicle shoots when the unmanned aerial vehicle flies an equal-spacing distance from a previous neighboring shooting position, and the images shot at various positions are then stitched together into a map image. The equal-spacing distance may be predicted by a flight altitude of the unmanned aerial vehicle, a flight wide-angle of a camera, and an overlapping rate of the images. A common way for equal-spacing shooting nowadays includes predicting a flight time needed for the unmanned aerial vehicle to fly the equal-spacing distance according to the equal-spacing distance and a flight speed of the unmanned aerial vehicle, setting the flight time as a shooting interval of the camera, and controlling the camera to shoot on time according to the shooting interval during the flight of the unmanned aerial vehicle, to obtain the image shot each the time when the unmanned aerial vehicle flies the equal-spacing distance from the neighboring shooting position before.

However, because the flight of the unmanned aerial vehicle may be affected by environments, such as a wind speed or a wind direction, the unmanned aerial vehicle may not be guaranteed to fly steadily at a preset flight speed, and a flight distance of the unmanned aerial vehicle during the shooting interval of the camera may be different from the equal-spacing distance. Therefore, an effect of the equal-spacing shooting may not be achieved accurately.

### SUMMARY

In accordance with the disclosure, there is provided a shooting control method including obtaining a distance between an unmanned aerial vehicle and a target point of a current shooting interval, determining whether the unmanned aerial vehicle satisfies a shooting time prediction condition according to the distance, predicting a time point at which the unmanned aerial vehicle arrives at the target point according to the distance if the unmanned aerial vehicle satisfies the shooting time prediction condition, and controlling an image device carried by the unmanned aerial vehicle to shoot at the time point.

Also in accordance with the disclosure, there is provided an unmanned aerial vehicle including a vehicle body, an image device arranged at the vehicle body, and a processor configured to execute a computer program to obtain a distance between the unmanned aerial vehicle and a target point of a current shooting interval, determine whether the unmanned aerial vehicle satisfies a shooting time prediction condition according to the distance, predict a time point at which the unmanned aerial vehicle arrives at the target point according to the distance if the unmanned aerial vehicle satisfies the shooting time prediction condition, and control the image device to shoot at the time point.

### BRIEF DESCRIPTION OF THE DRAWINGS

FIG. 1 is a schematic structural diagram of an example unmanned aerial system consistent with the present disclosure.

FIG. 2 is a schematic flow chart of a shooting control method according to an example embodiment of the present disclosure.

FIG. 3 is a diagram showing signaling interaction of a shooting control method according to an example embodiment of the present disclosure.

FIG. 4 is a schematic structural diagram of an example unmanned aerial vehicle consistent with the present disclosure.

### DETAILED DESCRIPTION OF THE EMBODIMENTS

To make the objectives, technical solutions, and advantages of the embodiments of the present disclosure clearer, the technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

As used herein, when a first component is referred to as “fixed to” a second component, it is intended that the first component may be directly attached to the second component or may be indirectly attached to the second component via a third component between them. When a first component is referred to as “connecting” to a second component, it is intended that the first component may be directly connected to the second component or may be indirectly connected to the second component via a third component between them.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

Some implementation manners of the present disclosure are described in detail below with reference to the drawings. When there is no conflict, the following embodiments and features of the embodiments may be combined with each other.

The embodiments of the present disclosure provide a shooting control method and an unmanned aerial vehicle (UAV). The UAV may be, for example, a rotorcraft, e.g., a multi-rotor aircraft propelled by a plurality of propulsion devices through the air, and the embodiments of the present disclosure are not limited thereto.

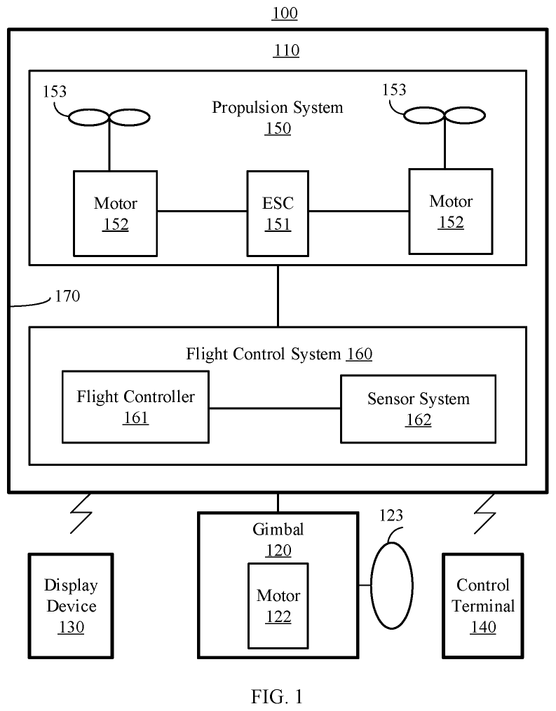

FIG. 1 is a schematic structural diagram of an example unmanned aerial system 100 consistent with the present disclosure. As shown in FIG. 1, in an example embodiment, a rotor UAV is taken as an example for description.

The unmanned aerial system 100 includes an unmanned aerial vehicle (UAV) 110, a display device 130, and a control terminal 140. The UAV 110 includes a propulsion system 150, a flight control system 160, a frame, and a gimbal 120 arranged at the frame. The UAV 110 may wirelessly communicate with the control terminal 140 and the display device 130.

The frame may include a vehicle body and a stand (also called a landing gear). The vehicle body may include a central frame, one or more vehicle arms connected to the central frame, and the one or more vehicle arms extend radially from the central frame. The stand is connected to the vehicle body and used to support the UAV 110 for landing.

The propulsion system 150 includes one or more electronic speed controllers (ESCs) 151, one or more propellers 153, and one or more motors 152 corresponding to the one or more propellers 153. The motor 152 is connected between the electronic speed controller 151 and the propeller 153, and the motor 152 and propeller 153 are arranged at the vehicle arm of the UAV 110. The electronic speed controller 151 is used to receive a driving signal generated by the flight control system 160, and supply driving current to the motor 152 to control the speed of the motor 152 according to the driving signal. The motor 152 is used to drive the propeller 153 to rotate, thereby providing power for the flight of the UAV 110, which enables the UAV 110 to achieve one or more degrees of freedom of movement. In some embodiments, UAV 110 may rotate around one or more rotation axes. For example, the rotation axis may include a roll axis, a yaw axis, and a pitch axis. The motor 152 may be a direct current (DC) motor or an alternating current (AC) motor. In addition, the motor 152 may be a brushless motor or a brushed motor.

The flight control system 160 includes a flight controller 161 and a sensor system 162. The sensor system 162 is used to measure attitude information of the UAV, that is, position information and status information of the UAV 110 in space, such as three-dimensional position, three-dimensional angle, three-dimensional velocity, three-dimensional acceleration, and three-dimensional angular velocity, etc. The sensor system 162 may include, for example, at least one of sensors such as a gyroscope, an ultrasonic sensor, an electronic compass, an inertial measurement unit (IMU), a vision sensor, a global navigation satellite system receiver, and a barometer. For example, the global navigation satellite system may be the global positioning system (GPS). The flight controller 161 is used to control the flight of the UAV 110. For example, the flight of the UAV 110 may be controlled according to the attitude information measured by the sensor system 162. The flight controller 161 may control the UAV 110 according to pre-programmed program instructions and may control the UAV 110 by responding to one or more control instructions from the control terminal 140.

The gimbal 120 includes a motor 122 and is used to carry an image device 123. The flight controller 161 may control the movement of the gimbal 120 via the motor 122. In some embodiments, the gimbal 120 may further include a controller to control the movement of the gimbal 120 by controlling the motor 122. The gimbal 120 may be separated from the UAV 110 or be a part of the UAV 110. The motor 122 may be a DC motor or an AC motor. In addition, the motor 122 may be a brushless motor or a brushed motor. The gimbal 120 may be located at the top of the UAV or at the bottom of the UAV.

The image device 123 may be, for example, a device for capturing images, such as a camera or a video camera. The image device 123 may communicate with the flight controller and shoot under the control of the flight controller. The image device 123 may include at least a photosensitive element, and the photosensitive element is, for example, a complementary metal oxide semiconductor (CMOS) sensor or a charge-coupled device (CCD) sensor. The image device 123 may be directly fixed at the UAV 110, therefore the gimbal 120 may be omitted.

The display device 130 is located at the ground terminal of the UAV 100, may communicate with the UAV 110 in a wireless manner, and may be used to display the attitude information of the UAV 110. In addition, the image shot by the image device may also be displayed on the display device 130. The display device 130 may be a separate device or integrated in the control terminal 140.

The control terminal 140 is located at the ground terminal of the UAV 100 and may communicate with the UAV 110 in a wireless manner for remote control of the UAV 110.

In addition, the UAV 110 may also carry a speaker (not shown), which is used to play audio files. The speaker may be directly fixed to the UAV 110 or mounted at the gimbal 120.

The above naming of various components of an unmanned aerial system is intended to describe example embodiments, instead of limiting the present disclosure. The shooting control method described in the following embodiments, for example, may be performed by the flight controller 161 to control the image device 123 to shoot.

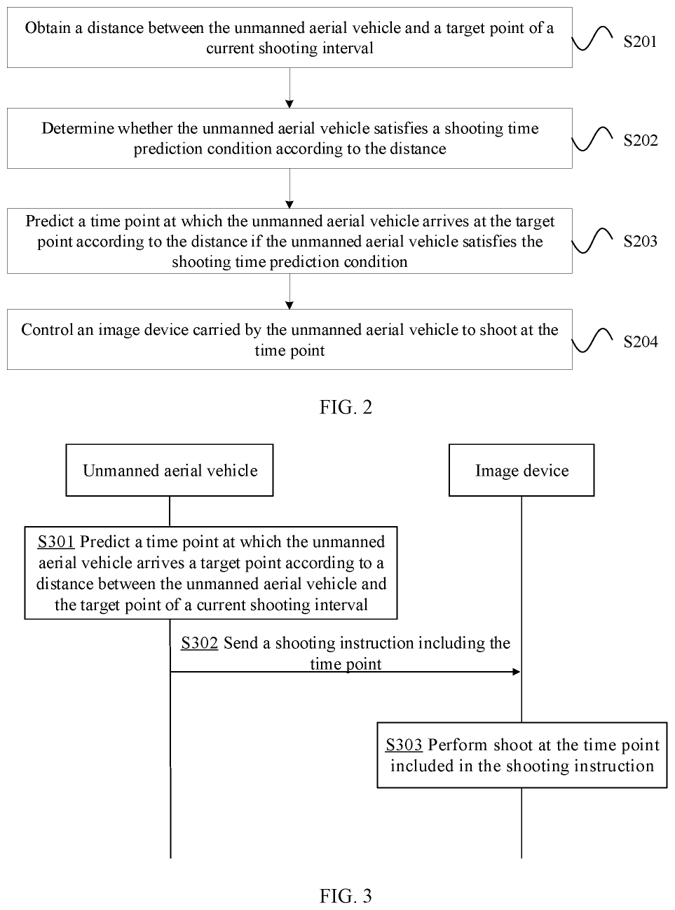

FIG. 2 is a schematic flow chart of a shooting control method according to an example embodiment consistent with the present disclosure. The shooting control method shown in FIG. 2 can, for example, be applied to the UAV 110 to control the image device 123 carried by the UAV 110 to shoot images.

As shown in FIG. 2, at S201, a distance between the UAV and a target point of a current shooting interval is obtained.

At S202, whether the unmanned aerial vehicle satisfies a shooting time prediction condition is determined according to the distance.

At S203, a time point at which the unmanned aerial vehicle arrives at the target point is predicted according to the distance if the unmanned aerial vehicle satisfies the shooting time prediction condition. This time point (or point in time or moment) is also referred to as a “predicted time point” (“predicted point in time” or “predicted moment”) or an “arrival time point.”

At S204, the image device carried by the UAV is controlled to shoot at the time point.

The target point of the current shooting interval is a desired shooting position. When the UAV is used for a scenario, such as panoramic shooting, surveying, or mapping, etc., shooting at intervals may be needed with a plurality of shooting intervals to shoot at the target point of each shooting interval. In an example embodiment, a distance (length) of each shooting interval and the number of the shooting intervals may be set according to actual needs of specific scenario. For example, to build a map of a digital city, the distances of the shooting intervals are same as each other to realize equal-spacing shooting to stitch the map easily. The length of the shooting interval may be determined, for example, according to a flight altitude of the unmanned aerial vehicle, a view angle of the image device carried by the UAV in a heading direction, and an overlapping rate of the images.

In some embodiments, when there are a plurality of shooting intervals, the shooting intervals may be distributed in a straight-line, in a polygonal, or irregularly.

In some embodiments, the UAV may obtain the distance between the UAV and the target point of the current shooting interval in real time.

In some embodiments, the distance between the UAV and the target point of the current shooting interval may be a straight-line distance between two points in a three-dimensional space.

In an example embodiment, the shooting time prediction condition is a condition that the UAV may predict the shooting time point.

In some embodiments, the shooting time prediction condition may be a distance threshold or a time threshold.

In an example embodiment, when the UAV satisfies the shooting time prediction condition, a flight time that the UAV needs to fly over the distance may be determined according to the distance between the UAV and the target point of the current shooting interval and a flight speed of the UAV, and then the time point at which the UAV arrives at the target point is predicted according to a current time point and the flight time. The flight speed of the UAV may be, for example, an instantaneous flight speed of the UAV at the current time point or an average flight speed of the UAV in a preset period of time, e.g., the average speed of the UAV within 10 minutes before the current time point.

In an example embodiment, the image device may be controlled by the UAV. After the time point is predicted, the UAV may determine in real time whether the predicted time point has been reached, i.e., whether the current time is the predicted time point. When the predicted time point has been reached, the image device may be controlled to shoot at the predicted time point.

In some embodiments, the UAV may send a shooting instruction to the image device by a wired and/or wireless manner. After the shooting instruction is received by the image device, the image device may shoot at the predicted time point when the UAV arrives at the target point according to the shooting instruction.

When the image device shoots according to the shooting instruction, the image device needs to be time synchronized with the UAV to accurately control the time point used to indicate shooting. If there is a time difference between the UAV and the image device, the time point used to indicate shooting may be determined according to a sum of or a difference between the predicted time point and the time difference, i.e., the time point used to indicate shooting may be determined by adding the time difference to or subtract the time difference from the predicted time point.

Before the predicted time point or at the predicted time point, the attitude of the UAV may be adjusted according to user operation or a preset instruction to meet shooting needs of the target point of the current shooting interval.

The shooting control method consistent with the embodiments of the present disclosure includes obtaining the distance between the UAV and the target point of the current shooting interval, determining whether the UAV satisfies the shooting time prediction condition according to the distance, predicting the time point at which the UAV arrives at the target point according to the distance when the UAV satisfies the shooting time prediction condition, and controlling the image device carried by the UAV to shoot at the time point. Thus, when the UAV flies at each shooting interval, the UAV may use the distance to predict the time when the UAV reaches the target point of the current shooting interval, without relying on the flight speed specified before the UAV flies. Because each shooting interval is used separately to predict the time point used to indicate the shooting, it is beneficial to adjust the time point in combination with the shooting interval and current state of the UAV, thereby realizing accurate control of the shooting time point, reducing a deviation between actual shooting position and the target point, and improving accuracy of shooting.

In some embodiments, one way to implement determining whether the UAV satisfies the shooting time prediction condition according to the distance includes determining whether the distance is equal to the sum of a preset distance and a shooting time distance corresponding to the current shooting interval. If the distance is equal to the sum of the preset distance and the shooting time distance corresponding to the current shooting interval, it can be determined that the UAV satisfies the shooting time prediction condition. If the distance is not equal to the sum of the preset distance and the shooting time distance corresponding to the current shooting interval, it can be determined that the UAV does not satisfy the shooting time prediction condition.

In an example embodiment, the shooting time prediction condition is measured by a distance threshold, which is equal to the sum of the preset distance and the shooting time distance corresponding to the current shooting interval.

Specifically, the preset distance may be determined according to factors such as the flight speed of the UAV, flight environment factor(s), e.g., a wind speed and a wind direction, and the flight altitude. For example, the preset distance may be positively related to a current flight speed of the UAV, that is, the preset distance may increase as the current flight speed of the UAV increases, and may decrease as the current flight speed of the UAV decreases. The preset distance may be a specific value or a value range. If the preset distance is the specific value, it can be determined whether the distance is equal to the sum of the preset distance and the shooting time distance corresponding to the current shooting interval. If the preset distance is the value range, it can be determined whether the distance falls within a value range of the sum of the preset distance and the shooting time distance corresponding to the current shooting interval. The preset distance may also be a constant value or a constant value range, which may be determined according to the length of the shooting interval.

In some embodiments, when the preset distance is the specific value, the preset distance may be 0. That is, determining whether the distance is equal to the sum of the preset distance and the shooting time distance corresponding to the current shooting interval may be determining whether the distance is equal to the shooting time distance corresponding to the current shooting interval.

The shooting time distance may be used to indicate that, before the image device is controlled to shoot, the time point of the current shooting interval used to indicate the shooting has been predicted, and after the time prediction, the UAV has not reached or passed the target point of the current shooting interval. As such, the image device can be controlled to shoot at the target point of the current shooting interval at the predicted time point. Thus, when the shooting instruction is sent by the UAV to the image device and the image device shoots at the predicted time point according to the shooting instruction, if the preset distance is not 0, then it means that the shooting instruction can be transmitted to the image device before the predicted time point, i.e., the UAV receives the shooting instruction before arriving at the target point of the current shooting interval; and if the preset distance is 0, then it means that when the predicted time point is reached, the shooting instruction has been transmitted to the image device and analyzed by the image device, i.e., the UAV may arrive at the target point of the current shooting interval right at the time that the reception and analysis of the shooting instruction is completed.

In an example embodiment, the preset distance may be greater than 0, which is conducive to reducing the deviation between the actual shooting position and the target point caused by a time delay when the image device shoots at the predicted time point according to the shooting instruction.

In some embodiments, the shooting time distances corresponding to various shooting intervals may be same as each other. For example, if the UAV is set to fly at a constant flight speed, the shooting time distances for various shooting intervals are set to be same as each other. The shooting time distance is irrelevant with a length of the current shooting interval.

In some embodiments, the shooting time distance may be a preset distance. The shooting time distance may be preset for different flight speeds, for example, a mapping relationship between the shooting time distance and the flight speed may be stored in the UAV in advance. When the image device is controlled to shoot, the current shooting time distance may be determined directly according to the mapping relationship, to reduce the computational workload of the UAV and improve the processing speed.

In some embodiments, on the basis of any of the above-described embodiments, the shooting time distance may be determined according to a preset time parameter and the current flight speed of the UAV. For example, the shooting time distance may be equal to a product of the current flight speed of the UAV and the preset time parameter.

In some embodiments, taking controlling the image device to shoot by the UAV as an example, the preset time parameter may include at least one of a determination time for determining whether the UAV satisfies the shooting time prediction condition, or a generation time for the time point. The determination time for determining whether the UAV satisfies the shooting time prediction condition is a period of time for the UAV to detect whether the UAV satisfies the shooting time prediction condition according to the distance. The generation time for the time point is a period of time needed by the UAV to predict the time point at which the UAV arrives at the target point according to the distance, when the shooting time prediction condition is satisfied. For example, to minimize the deviation between the actual shooting position and the target point of the current shooting interval, the preset time parameter may be the sum of the determination time for determining whether the UAV satisfies the shooting time prediction condition and the generation time for the time point.

In some embodiments, one way to implement determining whether the UAV satisfies the shooting time prediction condition according to the distance includes obtaining the flight time needed for the UAV to fly over the distance, and determining whether the flight time is equal to the sum of a preset time period and a shooting time period corresponding to the current shooting interval. If the flight time is equal to the sum of the preset time period and the shooting time period corresponding to the current shooting interval, it can be determined that the UAV satisfies the shooting time prediction condition. If the flight time is not equal to the sum of the preset time period and the shooting time period corresponding to the current shooting interval, it can be determined that the UAV does not satisfy the shooting time prediction condition.

In an example embodiment, the shooting time prediction condition is measured by a time threshold, which is equal to the sum of preset time period and the shooting time period corresponding to the current shooting interval.

Specifically, based on the flight speed of the UAV, the preset time period may be determined according to the preset distance determined above, and the shooting time period may be determined according to the shooting time distance determined above.

In some embodiments, one way to implement controlling the image device carried by the UAV to shoot at the time point includes transmitting the shooting instruction including the time point to the image device before the time point, to control the image device to shoot at the time point.

To ensure that the image device can shoot at the predicted time point, the time point when the UAV sends the shooting instruction to the image device needs to be before the predicted time point, thereby reducing the deviation between the actual shooting position and the target point of the current shooting interval because of the shooting delay caused by the transmission and/or analysis of the shooting instruction. If the shooting instruction is sent to the image device at or after the predicted time point, a large shooting delay may be caused, resulting in a large deviation between the actual shooting position and the target point of the current shooting interval. In this scenario, the UAV has passed the target point of the current shooting interval and entered a next shooting interval.

In an example embodiment, the shooting instruction includes the predicted time point by the UAV when the image device shoots, to control the image device to shoot at the time point.

FIG. 3 is a diagram showing signaling interaction of a shooting control method according to an example embodiment consistent with the present disclosure. As shown in FIG. 3, in an example embodiment, the shooting control method includes the following processes.

At S301, the UAV predicts the time point at which the UAV arrives at the target point according to the distance between the UAV and the target point of the current shooting interval.

At S302, the UAV sends the shooting instruction including the time point to the image device.

At S303, the image device performs shooting at the time point included in the shooting instruction.

For the implementation of process S301, reference may be made to the above-described embodiments, which is omitted here.

After the UAV predicts the time point to indicate shooting, the UAV may generate the shooting instruction including the time point and then send the shooting instruction including the time point to the image device.

When the image device receives the shooting instruction, the image device may analyze the shooting instruction, obtain the time point used to indicate shooting in the shooting instruction, and determine in real-time whether the time point included in the shooting instruction has been reached, i.e., whether the current time is the time point included in the shooting instruction. If the time point included in the shooting instruction has been reached, the image device shoots pictures.

In some embodiments, the time difference between the time point included in the shooting instruction and the time point when the shooting instruction is sent is greater than or equal to the sum of a transmission time for transmitting the shooting instruction and an analysis time for the image device to analyze the shooting instruction. That is, the shooting instruction needs to be sent in advance by at least a first time period, which is the sum of the transmission time of the shooting instruction and the analysis time for the image device to analyze the shooting instruction. As such, the UAV just arrives at the target point of the current shooting interval right when the image device finishes analyzing the shooting instruction, or the UAV would not arrive at the target point of the current shooting interval before the image device finishes analyzing the shooting instruction.

The transmission time for the shooting instruction is a period of time needed for the shooting instruction to be transmitted between the UAV and the image device, and can be, for example, determined according to the time difference between a time point at which the UAV transmits the shooting instruction and a time point at which the image device receives the shooting instruction. The transmission time for the shooting instruction depends on a communication manner between the UAV and the image device. For example, a wired communication manner, e.g., a transmission via a bus, needs a shorter transmission time than a wireless communication manner, e.g., transmission via Bluetooth.

The analysis time for the image device to analyze the shooting instruction is the period of time for the image device to obtain relevant information, such as a shooting parameter, the shooting time point, etc., from the shooting instruction. The analysis time for the image device to analyze the shooting instruction depends on processing performance of the image device, including the performance of hardware and software.

In some embodiments, taking shooting according to the shooting instruction by the image device as an example, if the shooting time distance is determined according to the preset time parameter and the current flight speed of the UAV, the preset time parameter may include at least one of the determination time for determining whether the UAV satisfies the shooting time prediction condition, the generation time for the shooting instruction (period of time for generating the shooting instruction), the transmission time for the shooting instruction, or the analysis time for the image device to analyze the shooting instruction. For example, the preset time parameter may be the sum of the transmission time for the shooting instruction and the analysis time for the image device to analyze the shooting instruction, and the shooting time distance may be equal to the product of the current flight speed of the UAV and the sum of the transmission time for the shooting instruction and the analysis time for the image device to analyze the shooting instruction.

In some embodiments, one way to implement obtaining the distance between the UAV and the target point of the current shooting interval includes obtaining current position information of the UAV, obtaining the distance between the UAV and the target point of the current shooting interval according to the current position information of the UAV and the position information of the target point of the current shooting interval.

In some embodiments, the target point may be set according to the preset flight route. For example, when the UAV performs a task such as surveying, mapping, etc., the flight route may be planned in advance to control the UAV to fly along a preset flight route and avoid the deviation from an execution position of the task. The target point may be the desired shooting position of the preset flight route. Taking security as an example, the target point may be a building, a site, etc., which needs to be a focus for safety monitoring of the preset route.

In some embodiments, the target point may be predicted according to a start point of the current shooting interval, the length of the current shooting interval, and a flight direction of the UAV. For example, when the UAV shoots freely and the distances between multiple shooting positions need to be set, the target point of the current shooting interval is predicted according to the length of each shooting interval. For example, if the start point of the current shooting interval is S, the length of the current shooting interval is 1 kilometer, and the flight direction of the UAV is north, then the target point is determined to be 1 kilometer north of the start point S.

As described above, the target point of the current shooting interval may be obtained, and the distance between the UAV and the target point of the current shooting interval may be predicted by obtaining the position information. Also, when there are multiple shooting intervals, predicting the distance between the UAV and the target point of the current shooting interval by obtaining the position information may ignore the start point of each shooting interval, thereby avoiding an error in determining the start point of each shooting interval from causing a large deviation between the actual shooting position and the target point. In particular, when the shooting intervals are same as each other, and equal-spacing shooting can be more easily realized by a method consistent with the disclosure.

In an example embodiment, the position information may include Global Positioning System (GPS) coordinates or Real-Time Kinematic (RTK) coordinates. Taking the GPS coordinates as an example, the position information includes three-dimensional information on longitude, latitude, and altitude that uniquely determine a point in the space. In an example embodiment, the current position information of the UAV and the position information of the target point of the current shooting interval may be represented in a same coordinate system, or in different coordinate systems. If different coordinate systems are used, the position information needs to be converted into the position information in the same coordinate system before the distance between the UAV and the target point is obtained.

In some embodiments, one way to implement obtaining the distance between the UAV and the target point of the current shooting interval includes obtaining a flight distance of the UAV and obtaining the distance between the UAV and the target point of the current shooting interval according to the flight distance of the UAV.

In some embodiments, the flight distance of the UAV is obtained starting from the start point of each shooting interval. For example, when the UAV flies in a straight line, the flight distance of the UAV may be determined by a flight mileage of the UAV, and the flight distance of the UAV may be equal to the difference between a current flight mileage and a flight mileage corresponding to the start point of the current shooting interval. Thus, the distance between the UAV and the target point of the current shooting interval may be determined according to the length of the current shooting interval and the flight distance of the UAV.

In some embodiments, a position of the UAV when the shooting time point of the current shooting interval is reached may be the start point of the next shooting interval.

In an example embodiment, obtaining the flight distance of the UAV by using the start point of each shooting interval as the origin point of the flight distance may avoid an effect of the historical accumulative error caused by the other shooting intervals on the current shooting interval, which is conducive to improving a matching rate between the actual shooting position and the target point, and avoiding mismatch between the flight distance and a length sum of the multiple shooting intervals caused by changes of the flight route.

In some embodiments, one way to implement obtaining the flight distance of the UAV includes obtaining the flight distance of the UAV starting from the start point of a first shooting interval, and obtaining the distance between the UAV and the target point of the current shooting interval according to the flight distance of the UAV, which includes obtaining the distance between the UAV and the target point of the current shooting interval according to the flight distance of the UAV and a number of shots of the image device.

For example, the flight route of the UAV is A-B-C-D-E, where position A is the start point of the first shooting interval, the length of shooting interval AB is 1 kilometer, the length of shooting interval BC is 2 kilometers, the length of shooting interval CD is 3 kilometers, and the length of shooting interval DE is 4 kilometers. If the flight distance of the UAV obtained starting from start point A is 8 kilometers, then the UAV is determined to be between position D and position E, the current shooting interval is determined to be shooting interval DE, a current number of shots of the image device is 3, the image device is desired to shoot a fourth time at position E, and the distance between the UAV and the target point of the current shooting interval, i.e., position E, is determined to be 2 kilometers.

Therefore, the flight distance of the UAV does not need to be zeroed during the flight of the UAV from the start point of the first shooting interval to the end of the last shooting interval, which is conducive to reducing the cost of computing resources when the flight route of the UAV is straight or includes multiple straight lines.

In some embodiments, one way to implement obtaining the flight distance of the UAV includes obtaining the position information of the origin point of the flight distance, obtaining the current position information of the UAV, and obtaining the flight distance of the UAV according to the position information of the origin point and the current position information of the UAV.

In an example embodiment, the flight distance is obtained starting from the origin point of the flight distance. If obtaining the flight distance of the UAV in the current shooting interval is needed, the start point may be the start point of the current shooting interval. If obtaining the flight distance of the UAV during shooting is needed, the start point may be the start point of the first shooting interval.

The above-described embodiments may be referred to for obtaining the position information, which is omitted here.

In some embodiments, on the basis of any of the above-described embodiments, the method also includes determining whether the current position of the UAV matches the target point at the time point, executing a preset strategy if the current position of the UAV does not match the target point at the time point.

The position information of the UAV at the time point can be obtained and the distance between the UAV and the target point of the current shooting interval at the time point can be determined. If the distance is shorter than a preset distance threshold, the current position of the UAV is determined to match the target point. If the distance is longer than or equal to the preset distance threshold, the current position of the UAV is determined to not match the target point. The preset distance threshold may be set as a relatively short distance as compared to the current shooting interval, for example, 0.01 meter, 0.02 meter, 0.03 meter, 0.04 meter, or 0.05 meter.

When the current position of the UAV does not match the target point, the preset strategy may be executed. For example, a warning message may be sent to a user through the control terminal of the UAV to prompt that a large error occurs, or information of the deviation of the current position of the UAV from the target point may be stored to provide a basis for subsequent data processing, e.g., map stitching may refer to the information of the deviation.

In some embodiments, the distances of various shooting intervals are same as each other to realize the equal-spacing shooting. The above-described technical solutions may realize the equal-spacing shooting with high accuracy.

The above-described embodiments may be combined with each other to construct more other embodiments, which are not limited here.

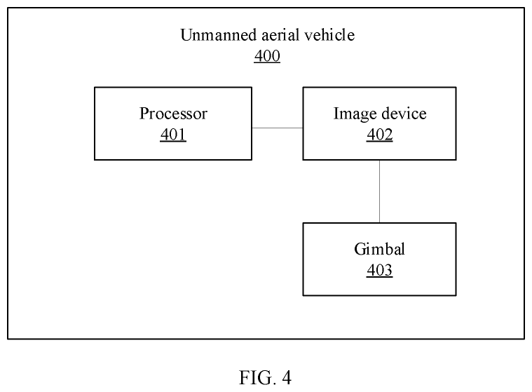

FIG. 4 is a schematic structural diagram of an example unmanned aerial vehicle 400 consistent with the present disclosure. As shown in FIG. 4, in an example embodiment, the UAV 400 includes a processor 401. A vehicle body of the UAV 400 carries an image device 402. The image device 402 is carried by the UAV 400 via a gimbal 403. In some other embodiments, the UAV 400 may not have the gimbal 403, and the image device 402 is directly carried by the vehicle body.

The processor 401 communicates with the image device 402. The processor 401 may be a central processing unit (CPU), another general-purpose processor, a digital signal processor (DSP), an application specific integrated circuit (ASIC), a field-programmable gate array (FPGA), another programmable logic device, another discrete gates or transistor logic device, or another discrete hardware component, etc. The general-purpose processor may be a microprocessor or another processor of any conventional processors, etc. The image device 402 may be, for example, a camera, a video camera, a smartphone, or a tablet, etc.

The processor 401 is configured to execute a computer program to obtain the distance between the UAV 400 and the target point of the current shooting interval, to determine whether the UAV 400 satisfies the shooting time prediction condition according to the distance, to predict the time point at which the UAV 400 arrives at the target point according to the distance when the UAV 400 satisfies the shooting time prediction condition, and to control the image device 402 to shoot at the time point.

Specifically, when the UAV is used in the field of aerial mapping, image data is desired to be obtained at the target point to meet the needs, such as digital city construction, security, and forest fire prevention, etc. However, because the flight of the UAV may be affected by environments, such as a wind speed or a wind direction, the actual shooting position may be deviated from the target point, which reduces the efficiency of the image data obtained from the shooting, and increases the workload of subsequent data analysis, such as map stitching, and reduces mapping efficiency.

The technical solutions of the above-described embodiments of the disclosure realize accurate control of the shooting time point, reduce the deviation between the actual shooting position and the target point, improve the accuracy of the shooting, improve the efficiency of the image data obtained from the shooting, reduce the workload of the subsequent data analysis, and further improve the mapping efficiency and enhance the user experience.

In some embodiments, the processor 401 is also configured to execute the computer program to determine whether the distance is equal to a sum of a preset distance and a shooting time distance corresponding to the current shooting interval, to determine that the UAV satisfies the shooting time prediction condition if the distance is equal to the sum of the preset distance and the shooting time distance corresponding to the current shooting interval, and to determine that the UAV does not satisfy the shooting time prediction condition if the distance is not equal to the sum of the preset distance and the shooting time distance corresponding to the current shooting interval.

In some embodiments, the preset distance may be positively related to a flight speed of the UAV.

In some embodiments, the shooting time distances corresponding to various shooting intervals may be same as each other.

In some embodiments, the shooting time distance may be a preset distance.

In some embodiments, the processor 401 is also configured to execute the computer program to determine the shooting time distance according to a preset time parameter and a current flight speed of the UAV.

In some embodiments, the preset time parameter includes at least one of a determination time for determining whether the UAV satisfies the shooting time prediction condition or a generation time for the time point.

In some embodiments, the processor 401 is also configured to execute the computer program to send a shooting instruction including the time point to the image device before the time point, to control the image device to shoot at the time point.

In some embodiments, the time difference between the time point included in the shooting instruction and the time point when the shooting instruction is sent is greater than or equal to the sum of a transmission time for transmitting the shooting instruction and an analysis time for the image device to analyze the shooting instruction.

In some embodiments, the preset time parameter includes at least one of the determination time for determining whether the UAV satisfies the shooting time prediction condition, the generation time for the shooting instruction, the transmission time for the shooting instruction, or the analysis time for the image device to analyze the shooting instruction.

In some embodiments, the processor 401 is also configured to execute the computer program to obtain current position information of the UAV, and to obtain the distance between the UAV and the target point of the current shooting interval according to the current position information of the UAV and position information of the target point of the current shooting interval.

In some embodiments, the processor 401 is also configured to execute the computer program to obtain a flight distance of the UAV, and to obtain the distance between the UAV and the target point of the current shooting interval according to the flight distance of the UAV.

In some embodiments, the processor 401 is also configured to execute the computer program to obtain the flight distance of the UAV starting from a start point of each shooting interval.

In some embodiments, a position of the UAV when the shooting time point of the current shooting interval is reached may be the start point of the next shooting interval.

In some embodiments, the processor 401 is also configured to execute the computer program to obtain the flight distance of the UAV starting from the start point of a first shooting interval, and to obtain the distance between the UAV and the target point of the current shooting interval according to the flight distance of the UAV and a number of shots of the image device.

In some embodiments, the processor 401 is also configured to execute the computer program to obtain the position information of an origin point of the flight distance, to obtain the current position information of the UAV, and to obtain the flight distance of the UAV according to the position information of the origin point and the current position information of the UAV.

In some embodiments, the target point is set according to a preset flight route.

In some embodiments, the target point is determined according to a start point of the current shooting interval, a length of the current shooting interval, and a flight direction of the UAV.

In some embodiments, the processor 401 is also configured to execute the computer program to determine whether a current position of the UAV at the time point matches the target point, and to execute a preset strategy if the current position of the UAV at the time point does not match the target point.

In some embodiments, the lengths of various shooting intervals may be same as each other.

A shooting control device (e.g., a chip, or an integrated circuit, etc.) consistent with the embodiments of the disclosure includes a memory and a processor. The memory stores the computer program to execute the shooting control method. The processor is configured to execute the computer program stored in the memory to perform the shooting control method as described in any of the embodiments of the present disclosure.

The method consistent with the disclosure may be implemented in the form of computer program stored in a computer-readable storage medium. The computer program may include instructions that enable relevant hardware to perform part or all of the method consistent with the disclosure, including the processes of the above-described embodiments. The storage medium may be any medium that may store program codes, for example, a read-only memory (ROM), a random-access memory (RAM), a magnetic disk, or an optical disk.

Although the above has shown and described the embodiments of the present disclosure, it is intended that the above embodiments be considered as examples only and not to limit the scope of the present disclosure. Those having ordinary skills in the art may make changes, modifications, replacements, and transformation to the above embodiments within a true scope spirit of the invention being indicated by the following claims.

What is claimed is:

1. A shooting control method comprising:
obtaining a distance between an unmanned aerial vehicle and a target point of a current shooting interval;
determining whether the unmanned aerial vehicle satisfies a shooting time prediction condition according to the distance;
predicting a time point at which the unmanned aerial vehicle arrives at the target point according to the distance in response to the unmanned aerial vehicle satisfying the shooting time prediction condition; and
controlling an image device carried by the unmanned aerial vehicle to shoot at the time point.

2. The method of claim 1, wherein determining whether the unmanned aerial vehicle satisfies the shooting time prediction condition according to the distance includes:
determining a sum of a preset distance and a shooting time distance corresponding to the current shooting interval; and
determining whether the unmanned aerial vehicle satisfies the shooting time prediction condition according to whether the distance is equal to the sum, including:
in response to the distance being equal to the sum, determining that the unmanned aerial vehicle satisfies the shooting time prediction condition; or
in response to the distance being not equal to the sum, determining that the unmanned aerial vehicle does not satisfy the shooting time prediction condition.

3. The method of claim 2, wherein the preset distance is positively related to a flight speed of the unmanned aerial vehicle.

4. The method of claim 2, wherein the shooting time distance corresponding to the current shooting interval equals a shooting time distance corresponding to another shooting interval.

5. The method of claim 4, wherein the shooting time distance corresponding to the current shooting interval and the shooting time distance corresponding to the another shooting interval are preset.

6. The method of claim 2, further comprising:
determining the shooting time distance according to a preset time parameter and a current flight speed of the unmanned aerial vehicle.

7. The method of claim 6, wherein the preset time parameter includes at least one of:
a determination time for determining whether the unmanned aerial vehicle satisfies the shooting time prediction condition, or
a generation time for the time point.

8. The method of claim 6, wherein controlling the image device to shoot at the time point includes, before the time point, transmitting a shooting instruction including the time point to the image device, to control the image device to shoot at the time point.

9. The method of claim 8, wherein a time difference between the time point and a time point at which the shooting instruction is transmitted is greater than or equal to a sum of a transmission time for the shooting instruction and an analysis time for the image device to analyze the shooting instruction.

10. The method of claim 8, wherein, the preset time parameter includes at least one of a determination time for determining whether the unmanned aerial vehicle satisfies the shooting time prediction condition, a generation time for the shooting instruction, a transmission time for the shooting instruction, or an analysis time for the image device to analyze the shooting instruction.

11. The method of claim 1, wherein obtaining the distance includes:
obtaining current position information of the unmanned aerial vehicle; and
obtaining the distance according to the current position information of the unmanned aerial vehicle and position information of the target point.

12. The method of claim 1, wherein obtaining the distance between the unmanned aerial vehicle and the target point includes:
obtaining a flight distance of the unmanned aerial vehicle; and
obtaining the distance according to the flight distance.

13. The method of claim 12, wherein obtaining the flight distance includes obtaining the flight distance starting from a start point of the current shooting interval.

14. The method of claim 13, wherein a position of the unmanned aerial vehicle at the time point is used as a start point of a next shooting interval.

15. The method of claim 12, wherein:
the current shooting interval is one of a plurality of shooting intervals of the unmanned aerial vehicle;
obtaining the flight distance includes obtaining the flight distance starting from a start point of a first shooting interval of the plurality of shooting intervals; and
obtaining the distance between the unmanned aerial vehicle and the target point according to the flight distance includes obtaining the distance between the unmanned aerial vehicle and the target point according to the flight distance and a number of shots of the image device.

16. The method of claim 12, wherein obtaining the flight distance includes:
obtaining position information of an origin point of the flight distance;
obtaining current position information of the unmanned aerial vehicle; and
obtaining the flight distance according to the position information of the origin point and the current position information of the unmanned aerial vehicle.

17. The method of claim 1, wherein the target point is set according to a preset flight route.

18. The method of claim 1, wherein the target point is determined according to a start point of the current shooting interval, a length of the current shooting interval, and a flight direction of the unmanned aerial vehicle.

19. The method of claim 1, further comprising:
determining whether a current position of the unmanned aerial vehicle at the time point matches the target point; and
executing a preset strategy in response to the current position of the unmanned aerial vehicle at the time point not matching the target point.

20. An unmanned aerial vehicle comprising:
a vehicle body;
an image device arranged at the vehicle body; and
a processor configured to execute a computer program to:
obtain a distance between the unmanned aerial vehicle and a target point of a current shooting interval;
determine whether the unmanned aerial vehicle satisfies a shooting time prediction condition according to the distance;
predict a time point at which the unmanned aerial vehicle arrives at the target point according to the distance in response to the unmanned aerial vehicle satisfying the shooting time prediction condition; and
control the image device to shoot at the time point.
